(19) United States
(12) Patent Application Publication
(10) Pub. No.: US 2021/0377016 A1
(43) Pub. Date: Dec. 2, 2021

(54) KEY ROLLOVER FOR CLIENT SIDE ENCRYPTION IN DEDUPLICATION BACKUP SYSTEMS

(71) Applicant: EMC IP Holding Company LLC, Hopkinton, MA (US)

(72) Inventors: Radia Perlman, Redmond, WA (US); Charles W. Kaufman, Redmond, WA (US); Senthilkumar Ponnuswamy, San Jose, CA (US)

(21) Appl. No.: 16/888,343

(22) Filed: May 29, 2020

(51) Int. Cl. H04L 9/08; H04L 9/06; G06F 11/14; G06F 16/215

(52) U.S. Cl. CPC H04L 9/0891; H04L 9/0656; G06F 2201/805; G06F 11/1453; G06F 16/215; H04L 9/0643

(57) ABSTRACT

Embodiments are described for re-keying encrypted data with a new encryption key. A server maintains a ClientBlocks list comprising (handle, hash) pairs for each client, a deduplication table, and encrypted data for one or more clients. Each client stores handles and encryption keys. The server goes through the ClientBlocks list looking for blocks that need to be re-encrypted, due to issuance of new encryption key. When the server finds a block that needs to be re-encrypted, it sends the ciphertext with its key ID to the client with a request to re-encrypt the data. The client then decrypts the data and re-encrypt it with a newer key identified by the newer key version. The server then writes newer key version, and new ciphertext someplace in physical storage, and replaces the pointer in the deduplication table with a pointer to the newly stored ciphertext block.

### TECHNICAL FIELD

Embodiments are directed to deduplication backup systems, and specifically to providing key rollover for client-side encryption operations.

### BACKGROUND

As data backup and storage systems become larger and more distributed, data security remains a critical need for enterprises and organizations that rely on data transfer and storage for operational and backup processes. The widespread adoption of cloud-based and public network storage as primary transfer and storage means often exposes sensitive and confidential data to potential unwanted access and exploitation. Protection of such data through encryption techniques using encryption keys between server and client computers in data storage systems has thus become common.

Large-scale data backup systems typically use deduplication techniques to eliminate duplicate copies of data to reduce storage requirements. Deduplication is particularly useful for systems that store data that is frequently updated or changed, as deduplication may be performed on blocks of data rather than on an entire file so that only the changed portion of data needs to be stored. Deduplication backup systems, such as DellEMC Data Domain, implement a form of single-instance storage to eliminate redundant copies of data to reduce storage overhead. Compression methods are used to store only one unique instance of data by replacing redundant data blocks with pointers to the unique data copy. As new data is written to a system, duplicate chunks are replaced with these pointer references to previously stored data.

Traditional deduplication methods are performed on plaintext data. However, current encryption methods normally prevent deduplication of the encrypted data. As a result, an enterprise may be unable to achieve the benefits of deduplication if it encrypts data at its source before transfer to storage. Because clients cannot always trust servers, they must be able to limit server access to the encryption keys and/or the plaintext of the data.

What is needed, therefore, is a deduplication backup method that allows clients to encrypt data with a key unknown to the server while still allowing the performance advantages of supporting data deduplication.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. EMC, Data Domain, and Data Domain Restorer are trademarks of DellEMC Corporation.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 illustrates a computer network system that implements one or more embodiments of key rollover and client-side encryption process in a deduplication backup system.

FIG. 2 illustrates an example block based backup operation, in accordance with some embodiments.

FIG. 3 illustrates a system that transmits encrypted data in a client-server storage system, under some embodiments.

FIG. 4A is a flowchart illustrating a method of re-keying encrypted data with a new encryption key, under some embodiments.

FIG. 4B is a flowchart illustrating certain data processing steps for the method of FIG. 4A, under some embodiments.

FIG. 5 is a flow diagram of client and server processes for a write operation, under some embodiments using the client-side and server-side processes described above.

FIG. 6 is a flow diagram of client and server processes for a read operation, under some embodiments using the client-side and server-side processes described above.

FIG. 7 is a flow diagram of client and server processes for a delete handle operation, under some embodiments.

FIG. 8 is a flow diagram of client and server processes for a rekeying operation, under some embodiments.

FIG. 9 is a block diagram of a computer system used to execute one or more software components of a key rollover and client-side encryption process, under some embodiments.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the invention.

Some embodiments of the invention involve automated backup techniques in a distributed system, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

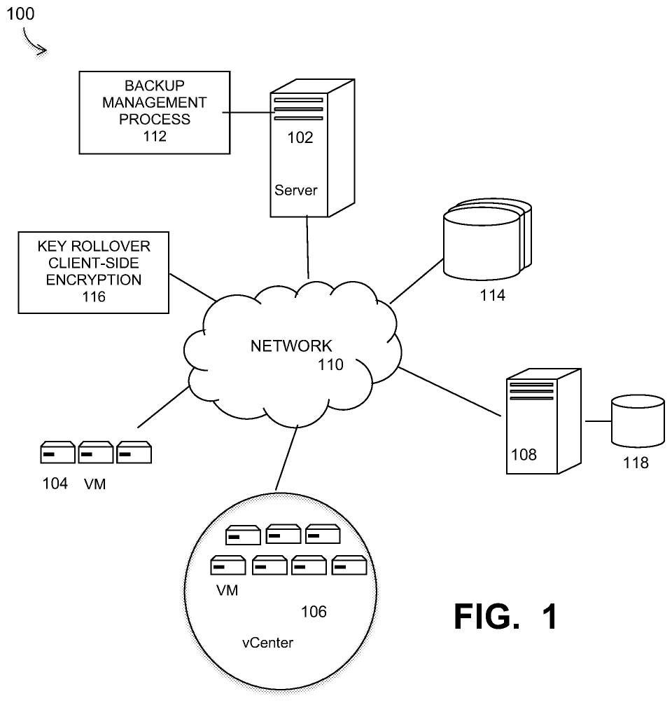

FIG. 1 illustrates a computer network system 100 that implements one or more embodiments of an encryption key rollover and client-side encryption process in a data backup system. In system 100, a number of backup targets, such as VMs or groups of VMs 104 are provided to backup data from one or more data sources. Target VMs may also be organized into one or more vCenters 106 representing a physical or virtual network of many virtual machines (VMs). The target storage devices backup data from one or more data sources, such as computer 108, which may have attached local storage 118 or use networked accessed storage devices 114.

The data sourced by a data source may be any appropriate data, such as database data that is part of a database management system. In this case, the data may reside on one or more hard drives (118 and/or 114) and may be stored in the database in a variety of formats. A network server computer 102 is coupled directly or indirectly to the backup targets (e.g., VMs 104 and 106), and to the data source 108 through network 110, which may be a cloud network, LAN, WAN or other appropriate network. Network 110 provides connectivity to the various systems, components, and resources of system 100, and may be implemented using protocols such as Transmission Control Protocol (TCP) and/or Internet Protocol (IP), well known in the relevant arts. In a distributed network environment, network 110 may represent a cloud-based network environment in which applications, servers and data are maintained and provided through a centralized cloud computing platform. In an embodiment, system 100 may represent a multi-tenant network in which a server computer runs a single instance of a program serving multiple clients (tenants) in which the program is designed to virtually partition its data so that each client works with its own customized virtual application, with each VM representing virtual clients that may be supported by one or more servers within each VM, or other type of centralized network server.

The data generated or sourced by system 100 may be stored in any number of persistent storage locations and devices, such as local client storage, server storage (e.g., 118), or network storage (e.g., 114), which may at least be partially implemented through storage device arrays, such as RAID components, and may support storage architectures such as storage area network (SAN), Network-attached Storage (NAS), or Direct-attached Storage (DAS) that make use of large-scale storage devices 114, such as optical or magnetic arrays. The data may be provided through VM or physical storage devices, and the target storage devices represent disk-based targets implemented through virtual machine technology.

For the embodiment of FIG. 1, network system 100 includes a server 102 that executes a data backup process 112 using deduplication technology. In an embodiment, system 100 may represent a Data Domain Restorer (DDR)-based deduplication storage system, and storage server 128 may be implemented as a DDR. Deduplication Storage server provided by DellEMC Corporation. However, other similar backup and storage systems are also possible. In general, Data Domain is a purpose-built backup appliance providing streaming deduplication that is able to ingest data at full network speeds, from multiple backup sources while providing storage efficiency.

The Data Domain File System (DDFS) is an example of an inline data deduplication file system. As data gets written to the file system, DDFS breaks it into variable sized segments and a group of segments are packed in a compression region. A number of compression regions are grouped together and written as a container to disk. DDFS calculates fingerprint signatures for each segment using a SHA1 (secure hash algorithm 1) algorithm. DDFS has an on-disk fingerprint index table that maps the fingerprint to the container-ID that has the corresponding segment data. The container has a metadata section followed by several data sections. The data sections store the compression regions; and the container metadata section stores the meta information of the container, i.e., it stores the total number of compression regions, the total number of segments, the fingerprint of each segment, and so on. In a deduplicated file-system that forms segments from data, these segments are uniquely identified by their key/label called a fingerprint. Given a file offset and length, the corresponding data segment fingerprints need to be looked up.

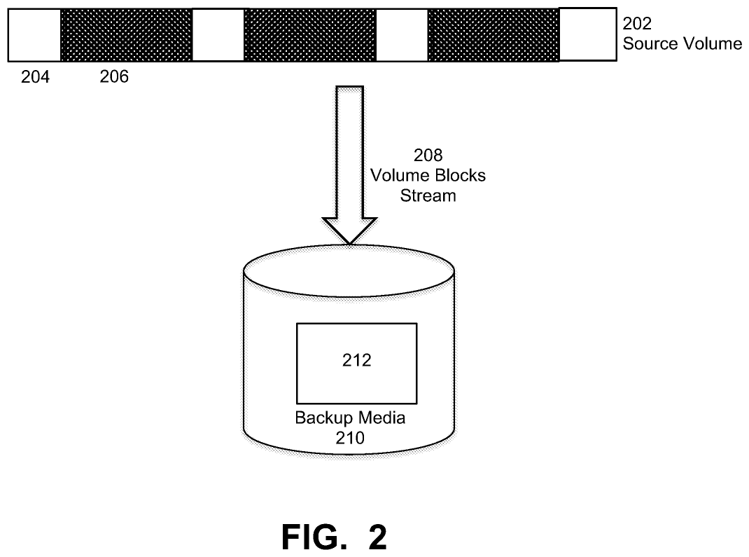

FIG. 2 illustrates an example block based backup operation, in accordance with some embodiments. As shown in FIG. 2, a source volume 202 comprises a number of used blocks 204 and unused blocks 206. During a backup process, the blocks of the source volume 202 are streamed 208 to the backup media 210 to produce backup saveset 212 comprising the backup of the source volume on the backup disk or VHD (virtual disk). In a block based backup system, the backup process reads the used blocks 204 in the order that they are on the source disk, not the order that they appear in files, which tend to be heavily fragmented, due to file system storage that scatters blocks of a file across the disk. As stated above, block based backups bypass the file system and read data directly form the source disk or volume. Block based backup applications can either read data in the same sized blocks as the file system or in different sized blocks. These used blocks are embedded as payload blocks in a virtual disk format such as VHDx and stored as backup savesets.

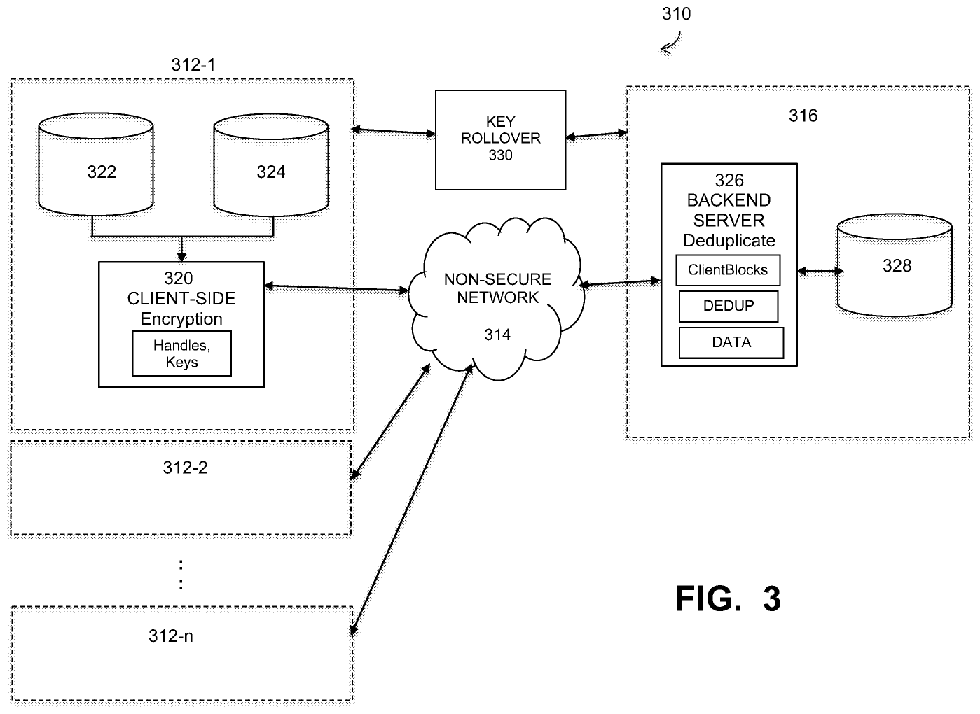

Embodiments are adapted for use with cloud-based deduplication, storage and backup systems, such as in a distributed processing and storage system of an enterprise that performs remote deduplication and storage of encrypted source data. FIG. 3 illustrates a system that transmits encrypted data in a client-server storage system, under some embodiments. In system 310, data is conveyed from a client-side subsystem 312-1 over a non-secure network 314 to a backend subsystem 316. The client-side subsystem may comprise a client-side server 320 (also referred to simply as a “client”) that processes source data in primary storage which may comprise hard disks 322, 324, for example, and stores the processed data in storage 328 of the backend system 316. Client 320 may encrypt the source data and transfer the encrypted data over the non-secure network 314 which may be a public or private data communications network that interconnects the client-side subsystem 312-1 with the backend subsystem 316 for transfer of data. The backend subsystem 316 may comprise a backend server 326 that deduplicates the received data from the client 320 and stores the deduplicated data in backend storage 328. Although FIG. 3 shows a single client-side server and a single backend server, it will be appreciated that system 310 may comprise any number of client-side and backend servers, such as illustrated by N possible client-side subsystems denoted 312-1, 312-2, and so on to 312-n.

As shown in FIG. 3, client 320 may encrypt primary source data and transfer the encrypted data over the network 314 to the backend server 326. The client 320 may also decrypt data returned via the network 314 from the backend server. The backend server 326 may deduplicate the encrypted data block in the write data received via the network from the client-side server without first decrypting it by deduplicating the hash of the plaintext data and its corresponding metadata in the write data block against previously stored hashes. If the received hash of the plaintext of the encrypted block in the write data is new, the server may store the ciphertext and metadata in the write block in backend storage 328. If, however, the hash and metadata already exist in storage, indicating that the data is duplicate data that has already been stored, the backend server does not store the data and metadata in the write block. The backend server 326 may comprise a DataDomain deduplication appliance of DellEMC, or any other similar system.

Data encryption can be performed by any appropriate encryption algorithm. One such encryption method uses a backend system that deduplicates and stores ciphertext that was encrypted by a client-side server without having access to either the plaintext or the encryption keys and without first decrypting the ciphertext. The backend systems deduplicate encrypted data blocks when the plaintext of two blocks is the same, even though the backend server and storage system see only encrypted data blocks. Moreover, an encrypted block of plaintext is deduplicated even if the client/server has done a key rollover between the time the client/server first encrypted the block and the time when the backend server stored the block to backend storage. The client/server may choose an arbitrary initialization vector (IV) for combining with the plaintext before creating the encrypted block of ciphertext, and the storage system stores only one version of an encrypted block that has been deduplicated. The IV may be, for example, either a random or pseudorandom non-repeating primitive, such as a number used once (nonce) that is combined with the plaintext prior to encryption to randomize the plaintext.

In an embodiment, the client-server system 300 includes a key rollover component or process 330 that allows the client 330 to encrypt data with a key that is unknown to the server 326, while still allowing the server to perform deduplication of the data. In this system and process, the client 326 is responsible for chunking of data into variable length blocks, performing any appropriate compression of data blocks, and encrypting the data blocks. Each client chunks the data into blocks and encrypts their respective blocks with an appropriate encryption key, 402. The server 326 performs the deduplication and allows multiple clients 312-1 to 312-n in the deduplication domain. For the embodiment of FIG. 3, the server 326 maintains a ClientBlocks list or table, a deduplication table (DEDUP) and the encrypted data (DATA), while the client 320 maintains the file handles and the encryption keys (both new and old key versions).

Encryption keys are periodically rolled over so that old keys are replaced with new keys to maintain security of the encryption system. In general, the key rollover process is dictated by a defined policy set by either the client or server. For example, a rollover policy may dictate that keys are replaced (refreshed) every 30, 60, or 90 days, or some similar period. At the end of the defined period, the old key is retired and any new data blocks are encrypted with a new key. In an embodiment, the server can deduplicate blocks encrypted by different clients in the same deduplication domain. In practical implementations, older keys must be accessible to decrypt old data blocks, and the system must be able to phase out old keys so that only new keys are used. Likewise, since different age data from the different clients can be encrypted with different keys, it is necessary that the server ensures that after key rollover, blocks encrypted with an older key will eventually be overwritten with ciphertext from a newer key. In an embodiment, the key rollover process 330 includes a mechanism whereby the server 326 does not know the encryption keys, but obtains help from one of the clients (312-1 to 312-n) that has stored a current data block, in order to get it encrypted with the newer key.

The server 326 keeps enough information to search through all the blocks stored by that client, and to know which ones were encrypted with an old key. A specific client (e.g., 312-1) then offers to help rekey the old blocks with the current key. The server then presents such blocks to that client, with sufficient metadata so that the client can decrypt the blocks with the old key and encrypt them with the new key. The server then overwrites the old ciphertext and metadata with the newly encrypted block. After a key rollover in which a new key replaces an old key, the system performs a rekeying sweep. If a client (e.g., 312-2) does not offer to rekey old blocks, any of its blocks that were duplicates of blocks stored by other clients that have gone through a rekeying sweep, will be refreshed with the new key. However, if that client has a block that is not a duplicate with any other client's block, that block will never be refreshed, until the client participates in a refresh.

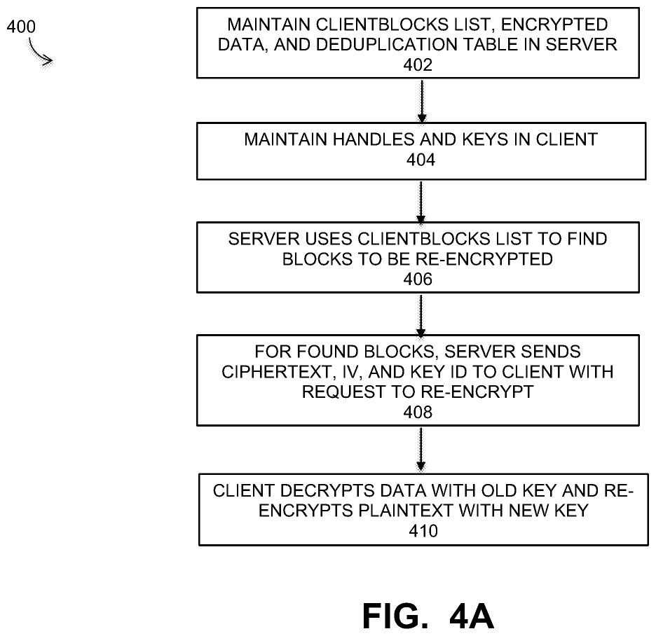

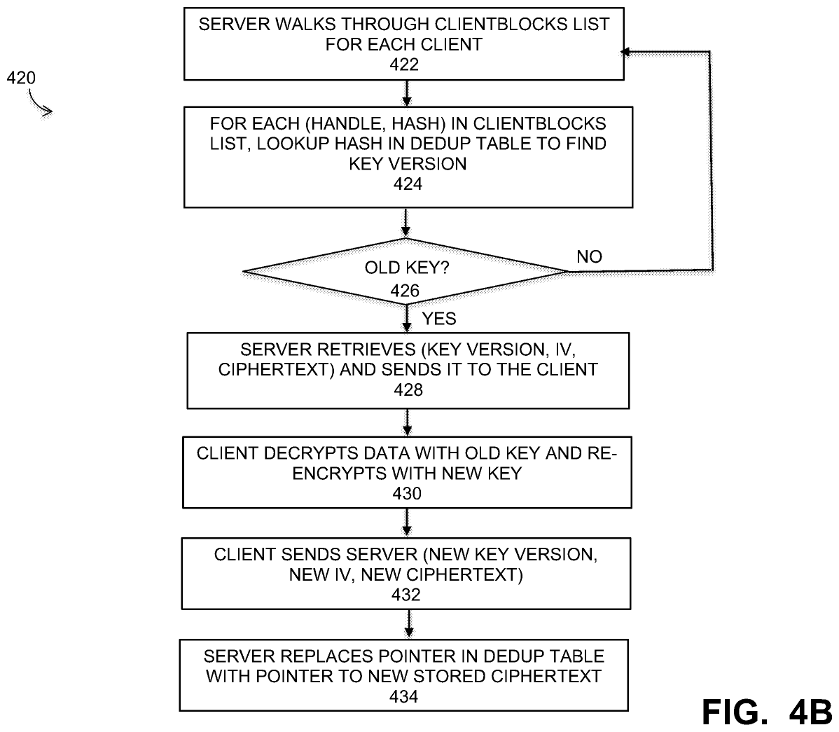

FIG. 4A is a flowchart illustrating a method of re-keying encrypted data with a new encryption key, under some embodiments. As shown in process 400 of FIG. 4, the server maintains a ClientBlocks list, the deduplication table, and the encrypted data, 402; while the client stores handles and encryption keys, 404. The server goes through the ClientBlocks list looking for blocks that need to be re-encrypted, 406. When the server finds a block that needs to be re-encrypted, the server sends the ciphertext with its key ID and IV to the client with a request to re-encrypt the data; 408. The client then decrypts the data and re-encrypts the plaintext with the new key, 410.

It should be noted that not all encryption methods an IV to randomize the plaintext. Thus, the use of an IV in encryption and re-encryption steps described herein, can be considered optional. That is, some embodiments may have an IV that is used for encryption and communicated and stored with the associated ciphertext, while others may not. It should also be noted the Clientblocks list and Deduplication table may each be implemented as a simple list, table, or other appropriate data structures. Thus, the terms “list” and “table” are generally used interchangeably, unless noted otherwise.

FIG. 4B is a flowchart illustrating certain data processing steps for the method of FIG. 4A, under some embodiments. As stored in the server, the ClientBlocks list consists of (handle, hash) pairs for each client. In process 450, the server walks through the ClientBlocks list for each client in the system, 422. For each item (handle, hash) in that list; it looks up the hash in the deduplication table to find the key version with which the block with that hash is stored, 424. If, as determined in step 426, that the key version is older than a defined threshold age (e.g., anything older than the latest key), the server retrieves (key version, IV, ciphertext), and sends to the client a re-key request for (handle, key version, IV, ciphertext), 428. The client decrypts the ciphertext with the key identified by the key version and IV to obtain the plaintext. Then the client chooses a new IV (or uses the old IV), and encrypts the plaintext and the new IV with the new key version, 430. The client then sends to the server (new key version, new IV, new ciphertext) 432. In general, the server does not send the handle to the client, and it does not need to send the hash. However, there must be some way for the server to make a request and match the response with the request, which can be done in one of several ways. One way is for the client's response to include the hash. In this case, the server just updates the information in the deduplication table and in the storage, for that hash. Another way is for the server to remember the hash it is asking for, and match responses with requests. One simple way is for the server to make a request “please rekey (key version, IV, ciphertext),” with the client responding with (hash, new key version, new IV, new ciphertext).

After step 431, the server writes (new key version, new IV, new ciphertext) someplace in physical storage, and replaces the pointer in the deduplication table with a pointer to the newly stored ciphertext block, 434. If the key version is stored in the deduplication table, then both the key version and the pointer to the stored ciphertext will be replaced in the node associated with that hash in the deduplication table. After the server has walked through the ClientBlocks list for a client, and all blocks with an older key version have been re-encrypted with the newer key, the server can send to a message to the client indicating that it can now delete all keys less than the defined threshold age.

It should be noted that the “new” key version or “newer” key version may be the newest key issued by the system, e.g., key version 10.0, or it may be some threshold key value for which older keys are replaced, For example, the newest key may be version 10.0, but the server may request the client to rekey everything older than key version 8.0, in which case the threshold key version is 8.0. The key version and new (or newer or newest) key versions are used to identify the appropriate key to perform the encryption and decryption operations at the client. The corresponding key versions are transmitted and stored as described. In general, the threshold key version indicates the key version below which blocks should be re-encrypted with a newer key version. This threshold version may or may not be the same as the newer or newest key version, as the client should re-encrypt the plaintext with the latest version that the client knows about, which may or may not be the threshold key version.

It should further be noted that in a multi-client system, the server need not do all the clients at once, it can perform the ClientBlocks list check and re-key request one client at a time.

With respect to server-side processes, for each ClientBlocks entry, the server looks up “hash” in the deduplication table to find the key version number. If the key version number is too old, then the server needs to look up the actual stored ciphertext and IV in physical storage. At this point, the server sends a re-key request to the client to re-key “key version, IV, ciphertext”, and receives back from the client (new key version, new IV, new ciphertext). The then server stores the new ciphertext and IV in storage, and updates the deduplication table for that hash with the newly stored ciphertext, and key version.

With respect to the server retrieval step 428 of FIG. 4B, for each item (handle, hash) in the ClientBlocks list, the server retrieves key version by looking at the deduplication table, which is indexed by hash, and contains a pointer to where the physical block associated with that hash is stored. The key version is preferably stored in the DDUP table, which saves the server a lookup if the node in the DDUP table is already marked with a sufficiently recent key version number. If the key version is new enough, then the server just goes on to the next item in that s ClientBlocks list. If the key version is stored in the same place as the ciphertext, or if the key version in the deduplication table is not recent enough, the server follows the link in the deduplication table to find the actual ciphertext. Stored with the ciphertext will be IV and possibly the key version number.

As described above, embodiments utilize ‘handles’ assigned by the client to each block, which are used to identify the block to the server. In a typically deployed system, the client sees an address space and asks the server for reads or writes based on the address in the client's address space, e.g., “write this amount of data starting at address X”, or “read this amount of data starting at address X”. The server typically has a block size (e.g., 4 KB), and keeps metadata per user block indicating where on disk that block is stored, and how many bytes the data is once stored (which may change due to compression). The handle in this case, is the address as perceived by the client (as opposed to where it is written on disk by the server). For maximum deduplication, data is sometimes partitioned in special places rather than at 4K boundaries. This is usually done at the server. However, for embodiments in which encryption is done at the client, as shown in FIG. 2, the client must make decisions about where the block boundaries are, which helps rekeying in the context of variable sized blocks.

With respect to handle processing, the client partitions the data into chunks, in any appropriate manner, and the chunks can be variable sizes, as stated above. To write a chunk, the client sends to the server the following information: [handle, hash, key version, IV, ciphertext]. The format of the handle is completely up to the client, and the server and client do need to agree on the size of the handle. The handle could be an address or a chunk number, or any similar location identifier. It is important, however, that the handle is unique for that particular client. The server does not use the handle for anything other than to keep track of which hash describes the data associated with that hash. In an embodiment, the server keeps track of client handles in the ClientBlocks table, which is a set of handle/hash pairs.

With respect to client-side data management, the server and client interact to rekey data blocks encrypted with old keys. In general, the client 320 manages its own data, so that if the client presents a file interface, the client decides where the block boundaries are (blocks can be variable length), and maintains a data structure that allows the client to read, write, delete, or overwrite any block of the file. The client assigns a handle to each block, which it uses to identify the block to the server. The handle only has to be unique with respect to that client, and does not need to have any other meaning. After breaking the file into blocks, the client, for each block, optionally compresses, and then encrypts each block.

The client then sends the following to the server (1) a hash of the plaintext (PT) of that block (which the server will use for deduplication), (2) the handle for the block, (3) the key version, (4) the initialization vector (IV) for encrypting the plaintext, and (5) the ciphertext. If any compression is used, the transmitted block must be encoded in such a way that indicates which compression algorithm was used, so that it can be properly decompressed. The client thus sends to the server, a data element comprising at least the following:

TABLE 1

| | | | | |
|---|---|---|---|---|
| Hash(PT) | Block Handle | Key Version | IV | Ciphertext |

It should be noted that for maximum deduplication efficacy, the clients in a deduplication domain (e.g., 312-1 to 312-n) should have similar strategies for where to start blocks. If clients use different chunking strategies, fewer blocks will be deduplicated, but no confusion will occur. It should also be noted that there is a minor security vulnerability of the server being able to do plaintext guessing by seeing the asserted hash of a block. To solve this (e.g., prevent the server from doing plaintext guessing based on the hash of the block), it is preferable for the clients in the deduplication domain to share a hash-secret K, and to send, as the hash of the block, a function of the plaintext block and K. For example, these can be as follows:
hash (K|plaintext block),
h(K h(plaintext block)) or
encrypting the hash of the plaintext block with K.

With respect to server-side data structures, in an embodiment, the server 326 keeps, for a particular client (e.g., 312-1), a list of hashes of blocks stored by that client (“ClientBlocks”), indexed by the handle asserted by the client. (where the handle is chosen by the client . . . see previous section). So, for client 312-1, the server keeps the following information in ClientBlocks:

{(handle 1, hash a), (handle 2, hash b), (handle 3, hash a), . . . }.

Note that if a client has stored the same plaintext block with different handles, that hash will appear twice in the ClientBlocks list (note handle 1 and handle 3 above). The server also keeps a deduplication table, where nodes in the table are hashes of blocks, as asserted by the client. The information at a node in the deduplication table consists of: (1) the physical location where server has stored the ciphertext of this block, (2) the key version with which it was encrypted (by a client), and (3) the IV chosen by the client that stored this block (though the IV might instead be kept with the ciphertext). The server thus maintains a deduplication table comprising at least the following shown in Table 2:

TABLE 2

| | | |
|---|---|---|
| Block Ciphertext Location | Key Version | IV |

When a client stores a block, the client will send its Table 1 data element (handle, hash, key version, IV, ciphertext). The server adds (handle, block) to the ClientBlocks list for this client, and then checks to see if the server already has that asserted hash in the deduplication table. If not, then the server creates a new node in the deduplication table, has that node point to where the ciphertext will be stored, and stores the new ciphertext and metadata (key version, IV). If the hash is already in the deduplication table, but with an older key version, then the server does not need to create a new node in the table, but it does need to overwrite the associated key version, IV, and ciphertext.

### Write Operations

When the server receives a request to write data (handle, hash, key version, IV, ciphertext), it uses the “hash” to look in the deduplication table to see if that chunk has already been stored. If so, the server checks the key version with which the ciphertext with that asserted plaintext hash has been stored. If the stored data associated with that hash was stored with key version the same or greater than the client's requested write, the server is done, and just needs to add (handle, hash) to its ClientBlocks table. If the hash is not in the deduplication table, or if the data associated with that hash was stored with an older key version, then the server replaces the stored block with (key version, IV, ciphertext), and perhaps updates the deduplication table to point to a new location on the disk (where the new ciphertext and metadata is now stored). It is an optimization for the metadata “key version” to be in the deduplication table rather than with the ciphertext, so that the server need not read the stored ciphertext from disk in order to compare the version numbers.

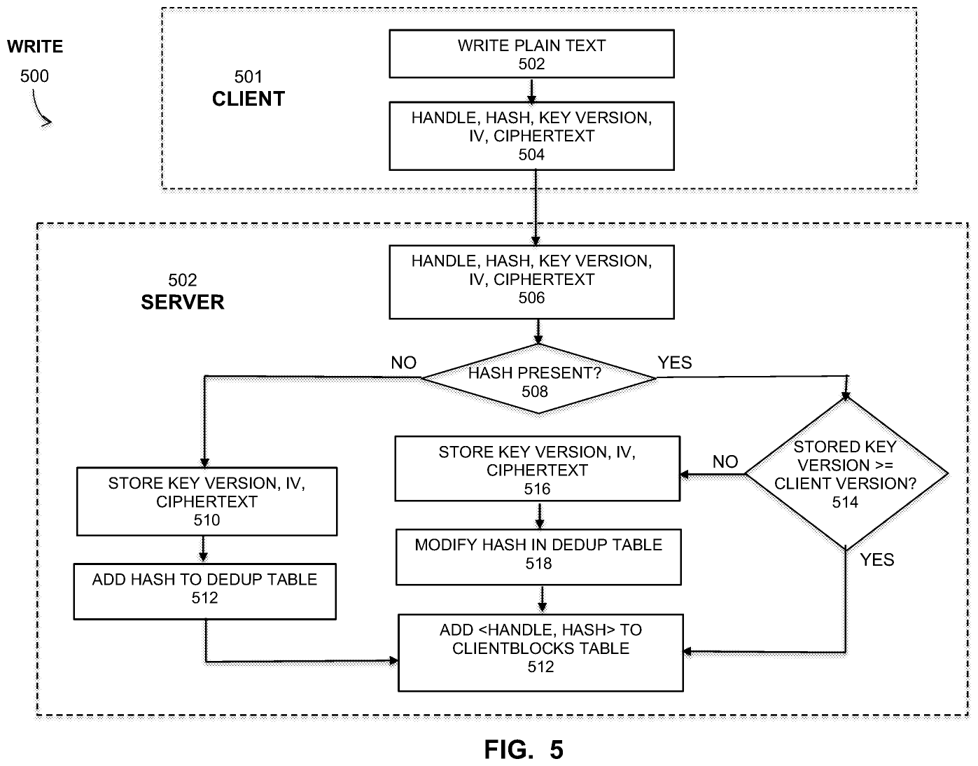

FIG. 5 is a flow diagram of client and server processes for a write operation, under some embodiments using the client-side and server-side processes described above. In process 500, the client 502 writes the plain text of data blocks to be processed, 502. It also generates for transmission to the server the data element shown in Table 1 and comprising the Handle, Hash, Key Version, IV, and Ciphertext, 504. The server 511 receives the data element 506 from the client. The server then determines whether the hash is present in the data element, 508. If the hash is not present, the server stores the other data elements (key version, IV, and ciphertext), 510. It then generates the hash and adds it to the deduplication table, 512. The server then adds the <Handle.Hash> to the ClientBlocks table, 512. If, in decision block 508 it is determined that the hash does exist in the client data element 506, the server next determines whether the stored key version is new (i.e., greater than or equal to the client version), 514. If the key is new, the server proceeds directly to add the <Handle.Hash> to the ClientBlocks table, 512. Otherwise, the server stores the key version, IV, and cipher text, 516. It then modifies the hash in the deduplication table 518 and then adds the <Handle.Hash> to the ClientBlocks table, 512.

An example of a write operation is provided in which the prefix w- is used to indicate the write request, and s- is used to indicate the stored value. If the client has overwritten data, the server might receive the request: (w-handle, w-hash, w-keyversion, w-IV, w-ciphertext), where the handle is already in the ClientBlocks list with (s-handle, s-hash); in other words: w-handle=s-handle. In that case, if w-hash=s-hash, the server checks the key version of “hash” in the DDUP table, and if the stored value is older, the server overwrites the stored block with the new (w-keyversion, w-IV, w-ciphertext). If w-keyversion is the same or older than what is currently stored, the server is done. If, however, w-hash does not equal s-hash, then the server replaces (handle, s-hash) with (handle, w-hash), and does the usual write of the data associated with w-hash. If it is already stored with the same key or greater key version, the server is done; otherwise, the server needs to store (key version, IV, ciphertext) in the DDUP table indexed with “hash”.

### Read Operations

When a client wants to read a block, it sends to the server the handle of the block. The server then sends (key version, IV, ciphertext). The client decrypts the block and performs any necessary decompression (if optional client-side compression was performed). To read a chunk, the client sends to the server handle. The server looks in the ClientBlocks table, finds that handle in the item (handle, hash), looks up the hash in the DDUP table to find where the actual ciphertext is stored, retrieves the ciphertext as well as the key version and ID, and sends to the client (handle, key version, IV, ciphertext). It is more optimal for the server to store the key version in the deduplication table, rather than with the ciphertext, so that the server does not need to actually read the block in order to know whether the newly received block has a later version number.

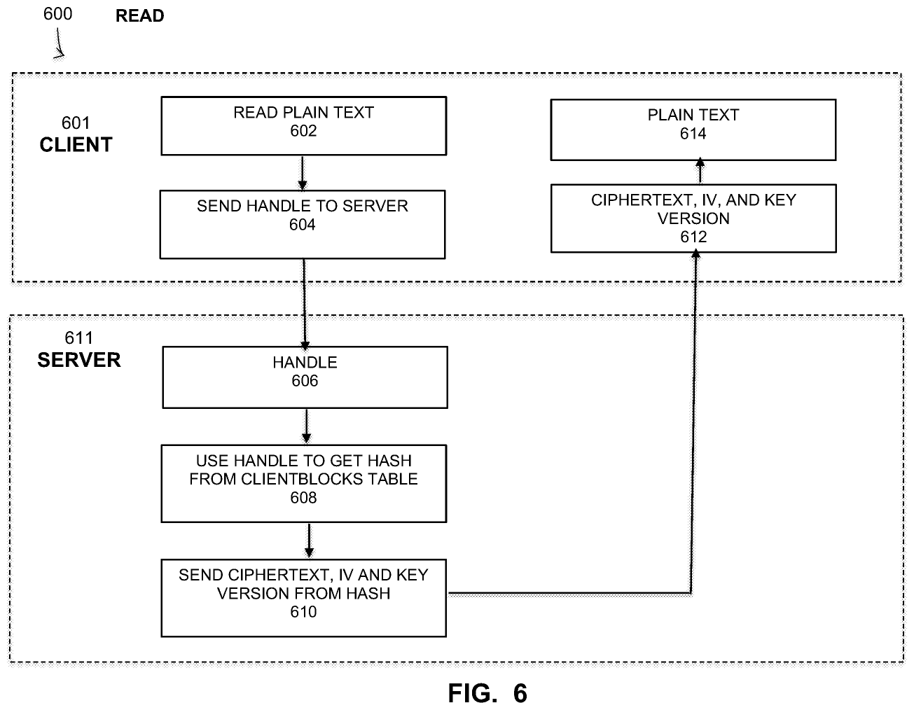

FIG. 6 is a flow diagram of client and server processes for a read operation, under some embodiments using the client-side and server-side processes described above. As shown FIG. 6, process 600 begins with the client 601 reading the data block plain text, 602, and sending the handle to the server, 604. The server 611 receives the handle 606 and uses it to get the hash from the ClientBlocks table, 608. It then sends back to the client the (ciphertext, IV, and key version) from the hash, 610. The client 601 receives this information, 612 and recovers the plain text of the data blocks, 614.

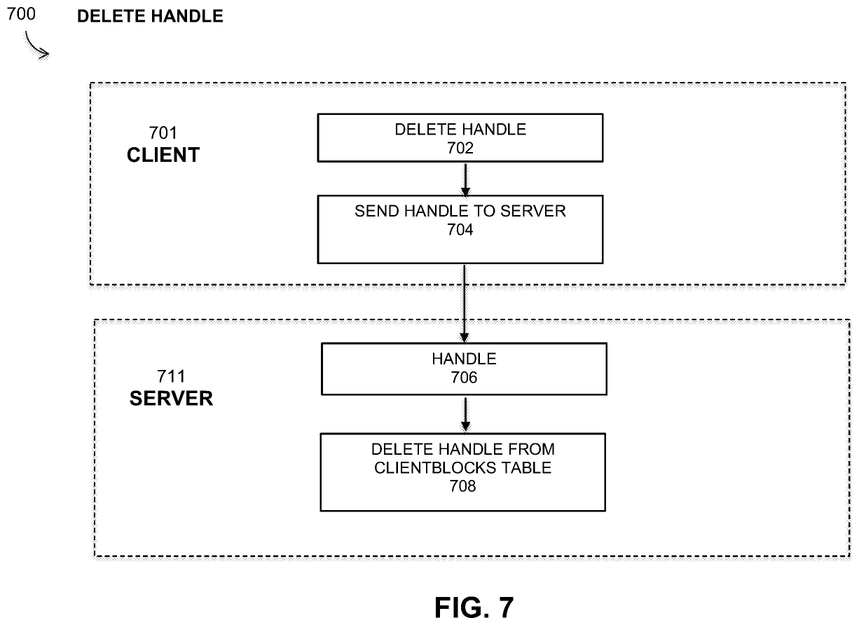

If the client deletes data, the server must be informed that all data associated with the deleted handles should be deleted. Thus, in this case, the client will tell the server to delete data associated with deleted handles, and the server should remove the specified information (handle, hash) from the ClientBlocks list. FIG. 7 is a flow diagram of client and server processes for a delete handle operation, under some embodiments. As shown in FIG. 7, process 700 starts with the client 701 deleting a handle, 702. It then sends this handle to the server, 704. The server 711 receives the handle, 706 and deletes it from the ClientBlocks table, 708.

In an embodiment, all clients in the same deduplication domain need to possess certain common knowledge, including the knowledge of the encryption keys, knowing when an old key can be deleted, and the hash secret. First, all domain clients need to know the same encryption keys. However, to install a new key, it will not be possible to instantaneously have them all receive the new key. Therefore, the procedure for installing a new key is: first, telling one-by-one, each client in the deduplication domain the new (key version, key), but that they should only store it, and not encrypt with it, though it can be used for decryption. After all the clients have been installed with the new key, one by one they are configured to start using that new key for encryption. All clients in the deduplication domain must keep all old keys (in case needed for decryption), until they know that an old key is no longer needed.

With respect to rekeying, a client can tell the server that it (the client) has resources and is willing to rekey blocks encrypted with keys less than the current version m. The server steps through this client's ClientBlocks list. For each (handle, hash), the server looks up that hash in the (server's) deduplication table, and checks the key version. If the key version is older than m, then the server sends to the client: (key version, IV, ciphertext). The client decrypts with that older key, and re-encrypts with the new key, and sends to the server (key version, IV, ciphertext)

In an example embodiment of rekeying, a client tells the server “I want to rekey all my data with key version older than kᵢ” The server steps through the ClientBlocks list, and for each (handle, hash), looks up the hash and key version in the DDUP table, and if the key version stored with “hash” is less than the server retrieves the ciphertext, sends to the client (handle, key version, IV, ciphertext), and the client decrypts and re-encrypts with the newer key version, and sends back (handle, new key version, new IV, new ciphertext). Note that once a client starts a request for getting rid of all data with key version older than it will not be writing new blocks with old keys, so there is no race condition of having the client store new blocks while the rekeying is going on. Once the server has gone through the whole ClientBlocks list, the server can inform the client that it can delete all keys older than In general, the client must know what handle is associated with which portion of the data. The client does not need to know what hash is associated with a chunk, just the handle.

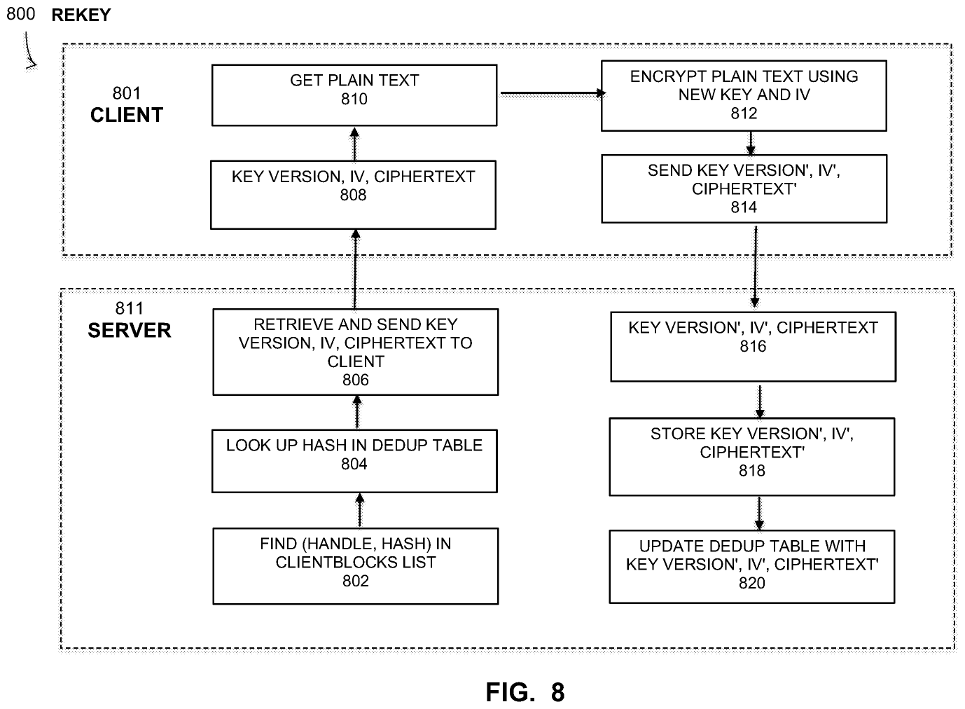

FIG. 8 is a flow diagram of client and server processes for a rekeying operation, under some embodiments. As shown in FIG. 8, process 800 starts with the server 811 finding the (handle, hash) in the Clientblocks list, 802. It then looks up the hash in the deduplication table 804, and finds that it has been encrypted with an old key. The server then retrieves (key version, IV, ciphertext), and sends that to the client to rekey, 806. In this case, the handle is not relevant, as the server just needs to know which request the client is responding to.

For the response, the client 801 receives the (key version, IV, ciphertext) information, 808, and gets the plaintext of the data block, 810. The client then encrypts this plaintext using the new key and IV, 812. The client then sends the new key version (key version′), new IV (IV′), and new ciphertext (ciphertext′) back to the server, 814. The server 811 receives this information, 816, and stores it, 818. The server then updates the deduplication with this new information: key version′, IV′, and ciphertext′, 820.

With respect to knowing when an old key can be deleted, after a rekeying sweep of a particular client's blocks, the server informs that client that all the client's blocks are encrypted with a key greater than or equal to version m. If the client has stored a new block in the middle of the rekeying process this is not a problem, since that newly stored block will have been stored with the most recent key. In other words, the rekeying sweep ensures that all blocks stored by that client will have been replaced with ciphertext encrypted with the latest key. It should be noted that it is not a problem for that client to delete all encryption keys with version less than m, if it has refreshed all of its own stored blocks so that they are encrypted with version m, even if there might be some blocks in the storage system (stored by other clients) encrypted with an older version, since those blocks are only stored by the other clients. If that particular client were to store a block already stored in the system by a different client (and therefore detected as a duplicate by the server's deduplication procedure), that client will be using key version m, and the newly written block (written by that client) will overwrite the older version block.

With respect to the hash secret, as noted before, there is a minor security vulnerability of the server being able to do plaintext guessing by seeing the asserted hash of a block. To solve this, it is preferable for the clients in the deduplication domain to share a permanent hash-secret K, and to send, as the hash of the block, a function of the compressed block and the hash-secret K. Ideally all clients in the same deduplication domain will use the same hash-secret K, and this secret would be permanent. If some sort of conformance requirement requires rolling over the hash-secret, or if different clients are configured with different hash-secrets, no data will be lost. The only downside is that a block whose hash is computed with a different hash-secret will not deduplicate with an identical block.

Embodiments are configured to handle variable block boundaries. It is the responsibility of the client to determine where the block boundaries are in its own data. The server just stores variable length blocks, whatever size the client asks to store. Since the client is doing compression, blocks will be variable length anyway. The client must write data to the server as a block, and if any re-blocking is to be done after the data is written, that re-blocking must be done by the client by reading back the relevant blocks and then writing out the new ones (or deleting the old blocks and writing new blocks).

In an embodiment, the client keeps track of the version number for each block. Alternatively, only the server keeps this information. This alternative embodiment is typically more efficient because a block that is a duplicate might have gotten overwritten with a newer key, and the client would not know that. In this alternative embodiment, the client does not need to know which key versions were used for each block.

There are generally no race conditions with clients storing the same block. Whoever stores a block first will have its ciphertext stored. If another client (e.g., 312-2) stores a block with the same hash, (and the same key version), that client's IV and ciphertext will be ignored, but the server will store the newly written (handle, hash) in ClientBlocks for that client.

Likewise, there are no race conditions with key versions with multiple clients in the same deduplication domain because all clients must be configured with the new key before any of them start encrypting with the new key. It is fine for a subset of them to know about the new key as long as they do not start encrypting with it. It is also fine for a subset of them to start encrypting with the new key, because all of the clients would know about the new key, and be able to decrypt with it, before any of the clients have permission to encrypt with it.

To do a rekeying sweep for a client, the server must step through that client's ClientBlocks list (each entry consisting of (handle, hash)), and for each one, look up the hash in the deduplication table to find the key version. If it is an old key version, the server must retrieve and send to the client (key version, IV, ciphertext). The client must decrypt with the old key and encrypt with the new key, and send (new key version, new IV, new ciphertext). This method is optimal, since only the client knows the encryption keys.

Embodiments of the key rollover and client-side encryption process allows the client to associate data blocks with handles, and use the handles in the interface to the server. The server keeps a ClientBlocks list. Rekeying is performed by having the server step through the ClientBlocks list, and use the client to do the decryption/re-encryption. It also provides a mechanism for knowing when it is safe to delete an old version key

### System Implementation

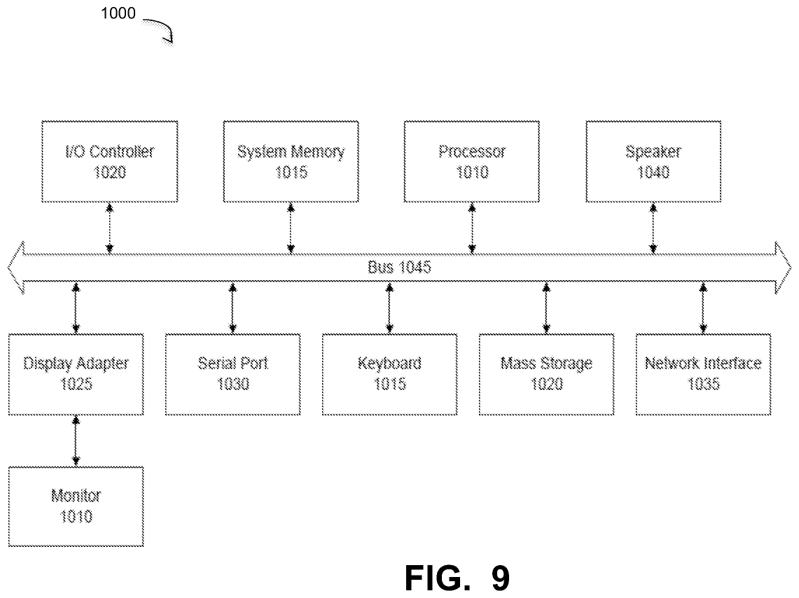

As described above, in an embodiment, system 100 includes a key rollover process 116 that may be implemented as a computer implemented software process, or as a hardware component, or both. As such, it may be an executable module executed by the one or more computers in the network, or it may be embodied as a hardware component or circuit provided in the system. The network environment of FIG. 1 may comprise any number of individual client-server networks coupled over the Internet or similar large-scale network or portion thereof. Each node in the network(s) comprises a computing device capable of executing software code to perform the processing steps described herein. FIG. 9 is a block diagram of a computer system used to execute one or more software components of the described process, under some embodiments. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 shown in FIG. 9 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®. family of systems (e.g., Windows Server), Linux, Mac OS X, IRIX32, or IRIX64. Other operating systems may be used. Microsoft Windows is a trademark of Microsoft Corporation.

Although certain embodiments have been described and illustrated with respect to certain example network topographies and node names and configurations, it should be understood that embodiments are not so limited, and any practical network topography is possible, and node names and configurations may be used. Likewise, certain specific programming syntax and data structures are provided herein. Such examples are intended to be for illustration only, and embodiments are not so limited. Any appropriate alternative language or programming convention may be used by those of ordinary skill in the art to achieve the functionality described.

Embodiments may be applied to data, storage, industrial networks, and the like, in any scale of physical, virtual or hybrid physical/virtual network, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network. The network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of re-keying encrypted data with a new encryption key in a system having a server and one or more clients, comprising:
storing, in the server, a ClientBlocks list consisting of (handle, hash) pairs for each client;
parsing through the ClientBlocks list and for each (handle, hash) pair, looking up the hash in a deduplication table to find a key version with which the block with that hash is stored;
if the key version is older than a threshold key version, retrieving by the server, the key version and ciphertext;
sending to the client a re-key request for the handle, key version, and ciphertext;
decrypting, in the client, the ciphertext with a key identified by key version to obtain corresponding plaintext;
encrypting; in the client, the plaintext with a newer key having a newer key version higher than the threshold key version and sending to the server the handle, hash, newer key version, and new ciphertext; and
writing the newer key version, new ciphertext in storage and replacing an original pointer in the deduplication table with a pointer the newly stored ciphertext block.

2. The method of claim 1 further comprising: after the re-encrypting step, sending, from the server to the client a message indicating that the client can delete all keys having key versions less than the threshold key version.

3. The method of claim 1 further comprising using an initialization vector (IV) comprising a random or pseudorandom number combined with the plaintext to create the ciphertext.

4. The method of claim 3 wherein:
the sending step sends to the client a re-key request for the key version, IV, and ciphertext;
the decrypting step decrypts the ciphertext with the key version and IV to obtain corresponding plaintext;
the encrypting step encrypts the plaintext with the newer key, and the IV or a new IV and sends to the server the newer key version, new IV, and new ciphertext; and
the writing step writes the newer key version, new IV, new ciphertext n storage.

5. The method of claim 3 wherein the ClientBlocks list stores a list of hashes of data blocks and indexed by the handle asserted by each client in a series of handle/hash pairs for each client.

6. The method of claim 3 wherein the deduplication table comprises nodes having hashes of data blocks asserted by the client, wherein a node includes a physical location where the server stores ciphertext of the data block, a key version used by the client to encrypt the data block, and the IV for the data block.

7. The method of claim 1 wherein the server stores one of: the key version with the ciphertext, or the key version in the deduplication table to prevent the need for the server to actually read the block in order to know whether a newly received data block has a more recent key version number.

8. A computer-implemented method of re-encrypting data with a new encryption key in a system having a server and one or more clients, comprising:
maintaining, in the server, a ClientBlocks list, a deduplication table, and encrypted data;
storing in each client, handles and encryption keys for data blocks encrypted by each respective client;
parsing through the ClientBlocks list to find blocks that need to be re-encrypted due to issuance of the new encryption key;
sending, for a found block, ciphertext with an associated key ID to a corresponding client with a request to re-encrypt the data; and
decrypting, at the corresponding client, the data; and
re-encrypting the data with the new encryption key.

9. The method of claim 8 further comprising: after the re-encrypting step, sending, from the server to the client to a message indicating that the client can delete all keys having key versions less than a threshold key version, wherein the threshold key version may be the same or different from the version of the new encryption key.

10. The method of claim 9 wherein the ClientBlocks list stores a list of hashes of data blocks and indexed by the handle asserted by each client in a series of handle/hash pairs for each client.

11. The method of claim 10 wherein the deduplication table comprises nodes having hashes of data blocks asserted by the client, wherein a node includes a physical location where the server stores ciphertext of the data block, a key version used by the client to encrypt the data block, and an Initialization Vector (IV) for the data block.

12. The method of claim 11 further comprising:
looking up, in the parsing step, for each (handle, hash) pair, the hash in a deduplication table to find a key version with which the data block with that hash is stored; and
if the key version is older than the threshold key version, retrieving by the server, the key version, IV, and ciphertext.

13. The method of claim 12 further comprising:
sending to the client a re-key request for the handle, key version, IV, and ciphertext;
decrypting, in the client, the ciphertext with a key identified by the key version and IV to obtain corresponding plaintext; and
encrypting, in the client, the plaintext with e new encryption key, and the IV or a new IV, and sending to the server the handle, hash, new encryption key version, new IV, and new ciphertext.

14. The method of claim 13 further comprising writing the new encryption key version, new IV, new ciphertext in storage and replacing an original pointer in the deduplication table with a pointer to the newly stored ciphertext block.

15. The method of claim 14 wherein the IV and the new IV each comprise an arbitrary value for combining with corresponding plaintext before creating the ciphertext to randomize the corresponding plaintext.

16. The method of claim 8 wherein the server stores the key version in one of: with the ciphertext, or in the deduplication table to prevent the need for the server to actually read the block in order to know whether a newly received data block has a more recent key version number.

17. The method of claim 8 wherein the system comprises a cloud-based deduplication backup system executing block-based backup operations on the data.

18. A computer-implemented method of re-encrypting data with a new encryption key in a system having a server and one or more clients, comprising:
maintaining, in a server computer, a ClientBlocks list storing a list of hashes of data blocks and indexed by the handle asserted by each client in a series of handle/hash pairs for each client;
looking up, for each ClientBlocks entry, a hash in a deduplication table to find a key version number used to encrypt the data blocks;
if the key version number is older than a threshold key version, then looking up stored ciphertext in physical storage;
sending a re-key request to the client to re-encrypt the data blocks with a newer key having a version higher than the threshold key version;
receiving back from the client the newer key version, new ciphertext of the data blocks;
storing the new ciphertext in storage; and
updating the deduplication table for the hash with the ne ciphertext, and the newer key version.

19. The method of claim 18 further comprising: after the re-encrypting step, sending, from the server to the client to a message indicating that the client can delete all keys having key versions less than the newer key version.

20. The method of claim 19 wherein the ClientBlocks list stores a list of hashes of data blocks and indexed by the handle asserted by each client in a series of handle/hash pairs for each client, and wherein the deduplication table comprises nodes having hashes of data blocks asserted by the client, wherein a node includes a physical location where the server stores ciphertext of the data block, a key version used by the client to encrypt the data block, and the Initialization Vector (IV) for the data block, wherein the IV comprises an arbitrary value for combining with corresponding plaintext before creating the ciphertext to randomize the corresponding plaintext.
